(19) United States
(12) Patent Application Publication
(10) Pub. No.: US 2013/0307169 A1
(43) Pub. Date: Nov. 21, 2013

(54) METHOD FOR MANUFACTURING MICRO-OPTICAL ELEMENT

(71) Applicants: HON HAI PRECISION INDUSTRY CO., LTD., NEW TAIPEI (TW); HONG FU JIN PRECISION INDUSTRY (SHENZHEN) CO., LTD., SHENZHEN (CN)

(72) Inventor: Feng CHENG, Shenzhen (CN)

(21) Appl. No.: 13/861,544

(22) Filed: Apr. 12, 2013

(30) Foreign Application Priority Data
Apr. 23, 2012 (CN) 201210119717.9

(51) Int. Cl. B29D 11/00

(52) U.S. Cl. CPC B29D 11/0074
USPC 264/1.27

(57) ABSTRACT

A method for manufacturing micro-optical element includes the following steps: (a) providing a mold core defining a plurality of replicated structures in a side surface of the mold core; (b) providing a transparent base board facing the side surface of the mold core defining the plurality of replicated structures; (c) distributing liquid replication material on the transparent base board corresponding to the plurality of the replicated structures via a droplet distribution tool; (d) molding the liquid replication material distributed on the transparent base board by the mold core; (e) solidifying the liquid replication material; (f) removing the mold core; and (g) cutting the transparent base board to form a plurality of micro-optical elements.

### BACKGROUND

1. Technical Field

The present disclosure relates to micro-optical elements, particularly to a method for manufacturing the micro-optical elements.

2. Description of Related Art

Micro-optical elements or components are typically produced by replication technique. To make a plurality of micro-optical elements at one time, a replication tool defining a plurality of replicated structures is provided, a transparent base board is provided, and liquid replication material is covered on the transparent base board. The liquid replication material is pressed by the replication tool to be shaped, and is then hardened by UV light to form micro-optical elements. However, as the liquid replication material is integrated, and a voltage of the liquid replication material is large, which will affect fluidity of the liquid replication material. Thus, depressions, air bubbles, or other defects will be formed in the micro-optical elements caused by poor fluidity of the liquid replication material.

Therefore, there is room for improvement in the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is a cross-sectional view of an embodiment of a manufacturing process for manufacturing a plurality of micro-optical elements.

FIG. 2 is a flowchart of an embodiment of a method for manufacturing a plurality of micro-optical elements of the present disclosure.

FIG. 3 is a cross-sectional view of an embodiment of a micro-optical element produced by the method of FIG. 2.

### DETAILED DESCRIPTION

FIGS. 1 through 3 shows that a micro-optical element 80 has a plurality of micro-structures 82 formed at a side surface of the micro-optical element 80. In the illustrated embodiment, each micro-structure 82 is an arc protrusion, and a size of each micro-structure 82 is controlled to be in a range from about 0.5 μm to about 200 μm.

As shown in FIG. 2, an embodiment of a method for manufacturing a plurality of micro-optical element is described as follows.

In step S201, a mold core 10 defining a plurality of replicated structures 102 is provided. In the illustrated embodiment, the mold core 10 includes a first side surface 104 and an opposite second side surface 106. The plurality of replicated structures 102 are defined in the second side surface 106. Each replicated structure 102 includes three separately arranged arc grooves. Each replicated structure 102 is used for replicating one micro-optical element 80 with a plurality of micro-structures 82.

In step S202, a supporting board 30, defining a plurality of through holes 302 that are corresponding to the plurality of replicated structures 102, is provided. In the illustrated embodiment, the supporting board 30 is a substantially flat board, and is located below the mold core 10. Each through hole 302 is located adjacent to one corresponding replicated structure 102. A diameter of each through hole 302 is the same as or more than a width of one corresponding replicated structure 102, thus UV light is capable of irradiating the replicated structures 120 through the through holes 302. The supporting board 30 is made of organic materials, metallic materials or ceramic materials.

In step S203, a transparent base board 50 is loaded on the supporting board 30 and faces the second side surface 106 of the mold core 10. In the illustrated embodiment, the transparent base board 50 is a substantially flat board. The transparent base board 50 is located between the mold core 10 and the supporting board 30 and adjacent to the second side surface 106 of the mold core 10. The transparent base board 50 is selected from the group consisting of polyethylene terephthalate and polybutylene terephthalate. It is clearly that the transparent base board can be made of other transparent organic materials, such as polyvinylchloride (PVC), polymethylmethacrylate (PMMA).

In step S204, a liquid replication material 70 is distributed on the transparent base board 50 corresponding to the plurality of the replicated structures 102 via a droplet distribution tool 60. In the illustrated embodiment, the liquid replication material 70 is selected from the group consisting of epoxy, polyurethane-acrylate, and polydimethylsiloxane. In other embodiments, the liquid replication material 70 can be made of other UV-curing materials. The droplet distribution tool 60 is an automatic droplet dispensing machine. In an alternative embodiment, the droplet distribution tool 60 can be a droplet distribution mechanism driven by a robot, and the droplet distribution mechanism defines a plurality of outlets corresponding to the plurality of replicated structures 102. Alternatively, the liquid replication material 70 can be made of heat curing materials.

In step S205, the liquid replication material 70 distributed on the transparent base board 50 is molded by the mold core 10. In the illustrated embodiment, the mold core 10 moves towards the transparent base board 50 until each of the plurality of the replicated structures 102 is filled with the liquid replication material 70.

In step S206, the liquid replication material 70 is solidified. In the illustrated embodiment, the liquid replication material 70 is solidified by exposure to UV light. The UV light irradiates the liquid replication material 70 through the through holes 302 of the supporting board 30 to solidify the liquid replication material 70.

In step S207, the mold core 10 is removed.

In step S208, the transparent base board 50 is cut to form a plurality of micro-optical elements 80.

It is clear that a height of the micro-optical element 80 can be changed by controlling a distance between the mold core 10 and the transparent base board 50.

Alternatively, certain of the steps described above may be removed, others may be added, and the sequence of steps may be altered. For example, the supporting board 30 can be omitted, and the UV light directly irradiates the transparent base board 50.

In an alternative embodiment, an area of a top surface of the supporting board 30 can be several times as large as an area of the second side surface 106 of the mold core 10. In addition, an area of a top surface of the transparent base board 50 may be the same as the area of the top surface of the supporting board 30. The number of the through holes 302 of the supporting board 30 is several times as great as the number of the replicated structures 102 correspondingly. In use, steps S205 to S207 are repeated several times to mold and solidify the liquid replication material 70 that is distributed on the transparent base board 50, which can improve the efficiency of making or fabricating the micro-optical elements 80.

The method of making the plurality of micro-optical elements 80 in the present disclosure is performed by distributing the liquid replication material 70 to the transparent base board 50 corresponding to the plurality of the through holes 302 via the droplet distribution tool 60, which divides the liquid replication material 70 into a plurality of smaller droplet parts. As each smaller part of the liquid replication material 70 has a smaller voltage and better fluidity, which will prevent the micro-optical elements 80 from forming depressions, air bubbles, or other defects caused by poor fluidity of the liquid replication material 70, thus improving the quality of the micro-optical element 80 that are fabricated.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A method for manufacturing micro-optical element, the method comprising:
(a) providing a mold core defining a plurality of replicated structures in a side surface of the mold core;
(b) providing a transparent base board facing the side surface of the mold core defining the plurality of replicated structures;
(c) distributing a liquid replication material on the transparent base board corresponding to the plurality of the replicated structures via a droplet distribution tool;
(d) molding the liquid replication material distributed on the transparent base board by the mold core;
(e) solidifying the liquid replication material;
(f) removing the mold core; and
(g) cutting the transparent base board to form a plurality of micro-optical elements.

2. The method for manufacturing the micro-optical element of claim 1, wherein the mold core comprises a first side surface and a second side surface opposite to the first side surface, the plurality of replicated structures are defined in the second side surface, and the transparent base board is located between the mold core and the supporting board and adjacent to the second side surface of the mold core.

3. The method for manufacturing the micro-optical element of claim 1, wherein the transparent base board is made of transparent organic materials.

4. The method for manufacturing the micro-optical element of claim 1, wherein the transparent base board is selected from the group consisting of polyethylene terephthalate, polybutylene terephthalate, and a combination thereof.

5. The method for manufacturing the micro-optical element of claim 1, wherein the liquid replication material is made of UV-curing materials.

6. The method for manufacturing the micro-optical element of claim 1, wherein the liquid replication material is selected from the group consisting of epoxy, polyurethane-acrylate, or polydimethylsiloxane, and a combination thereof.

7. The method for manufacturing the micro-optical element of claim 1, wherein the droplet distribution tool is an automatic droplet dispensing machine.

8. The method for manufacturing the micro-optical element of claim 1, wherein a diameter of each through hole is the same as or more than a width of one corresponding replicated structure.

9. A method for manufacturing micro-optical element, the method comprising:
(a) providing a mold core defining a plurality of replicated structures in a side surface of the mold core;
(b) providing a supporting board defining a plurality of through holes corresponding to the plurality of replicated structures;
(c) providing a transparent base board loaded on the supporting board and facing the side surface of the mold core defining the plurality of replicated structures;
(d) distributing a liquid replication material on the transparent base board corresponding to the plurality of the replicated structures via a droplet distribution tool;
(e) molding the liquid replication material distributed on the transparent base board by the mold core;
(f) solidifying the liquid replication material;
(g) removing the mold core; and
(h) cutting the transparent base board to form a plurality of micro-optical elements.

10. The method for manufacturing the micro-optical element of claim 9, wherein the mold core comprises a first side surface and a second side surface opposite to the first side surface, the plurality of replicated structures are defined in the second side surface, and the transparent base board is located adjacent to the second side surface of the mold core.

11. The method for manufacturing the micro-optical element of claim 9, wherein the transparent base board is made of transparent organic materials.

12. The method for manufacturing the micro-optical element of claim 9, wherein the transparent base board is selected from the group consisting of polyethylene terephthalate, polybutylene terephthalate, and a combination thereof.

13. The method for manufacturing the micro-optical element of claim 9, wherein the liquid replication material is made of UV-curing materials.

14. The method for manufacturing the micro-optical element of claim 9, wherein the liquid replication material is selected from the group consisting of epoxy, polyurethane-acrylate, or polydimethylsiloxane, and a combination thereof.

15. The method for manufacturing the micro-optical element of claim 9, wherein the droplet distribution tool is an automatic droplet dispensing machine.

16. A method for manufacturing micro-optical element, the method comprising:
(a) providing a mold core defining a plurality of replicated structures in a side surface of the mold core;
(b) providing a supporting board defining a plurality of through holes corresponding to the plurality of replicated structures, wherein an area of a top surface of the supporting board is several times as large as an area of the side surface defining the plurality of replicated structures, and the number of the through holes of the supporting board is several times as great as the number of the replicated structures correspondingly;
(c) providing a transparent base board loaded on the supporting board and facing the side surface of the mold core defining the plurality of replicated structures, wherein an area of a top surface of the transparent base board is the same as the area of the top surface of the supporting board;
(d) distributing a liquid replication material on the transparent base board corresponding to the plurality of the through holes via a droplet distribution tool;
(e) molding a portion of the liquid replication material distributed on the transparent base board by the mold core;
(f) solidifying the liquid replication material molded by the mold core;
(g) removing the mold core;
(h) repeating steps (e) through (g) to mold and solidify one or more portions of the liquid replication material until a total amount of the distributed liquid replication material of step (d) is reached;
(i) cutting the transparent base board to form a plurality of micro-optical elements.

17. The method for manufacturing the micro-optical element of claim 16, wherein the mold core comprises a first side surface and a second side surface opposite to the first side surface, the plurality of replicated structures are defined in the second side surface, and the transparent base board is located adjacent to the second side surface of the mold core.

18. The method for manufacturing the micro-optical element of claim 16, wherein the transparent base board is made of transparent organic materials.

19. The method for manufacturing the micro-optical element of claim 16, wherein the transparent base board is selected from the group consisting of polyethylene terephthalate, polybutylene terephthalate, and a combination thereof.

20. The method for manufacturing the micro-optical element of claim 16, wherein the liquid replication material is made of UV-curing materials.
